(19) United States
(12) Patent Application Publication
(10) Pub. No.: US 2014/0265146 A1
(43) Pub. Date: Sep. 18, 2014

(54) COMPOSITE DYNAMIC SEAL MATING RING OR ROTOR

(71) Applicant: Eaton Corporation, Cleveland, OH (US)

(72) Inventor: Adam Matthew Danaher, North Attleborough, MA (US)

(21) Appl. No.: 13/903,520

(22) Filed: May 28, 2013

Related U.S. Application Data
(63) Continuation-in-part of application No. 13/833,405, filed on Mar. 15, 2013, now abandoned.

(51) Int. Cl. F16J 15/40

(52) U.S. Cl. CPC F16J 15/40
USPC 277/411

(57) ABSTRACT

A hydrodynamic mating ring includes a base and an insert coupled to the base. In embodiments, an insert has a coefficient of thermal expansion greater than the coefficient of thermal expansion of the base. A hydrodynamic seal assembly including a corresponding stator is also disclosed.

### TECHNICAL FIELD

The present disclosure relates to mechanical seals, including, hydrodynamic seals.

### BACKGROUND

Mechanical seals are widely used to provide a seal between a stationary housing, often containing a fluid such as oil, and a rotating shaft that passes through the housing. Typically, such seals include a stationary sealing ring (e.g. a stator) about the shaft but fixed to the housing, and another sealing ring (e.g. a mating ring or a rotor), which rotates with the rotating shaft.

Contact between the stator and rotor during operation may create friction resulting in heat. If the amount of heat is undesirable it could potentially damage the seal, which could cause undesired deformation with respect to the sealing faces of the rotor and/or stator, and could potentially impair other nearby elements.

Hydrodynamic seals attempt to reduce friction by including grooves of some form in the sealing face of the rotor, for example, and without limitation, the grooves as described in U.S. Patent Application Publication No. 2006/0244221 (Villeneuve et al.), which is assigned to the assignee of this application, and is hereby incorporated herein by reference. The grooves may facilitate formation of a layer of fluid between a stator and a rotor during operation. The layer of fluid may cause a separation between the stator and rotor, which may be referred to as “lift off.” However, under some conditions heat may still be generated and could impair desired lift off.

### SUMMARY

A hydrodynamic mating ring includes a base and an insert coupled to the base. In embodiments, an insert has a coefficient of thermal expansion greater than the coefficient of thermal expansion of the base. A hydrodynamic seal assembly including a corresponding stator is also disclosed.

### BRIEF DESCRIPTION OF THE DRAWINGS

Embodiments of the invention will now be described, by way of example, with reference to the accompanying drawings, wherein:

FIG. 1 is a cross-sectional view of an embodiment of a mating ring shown generally in accordance with teachings of the disclosure.

FIG. 2 is three-dimensional view of another embodiment of a mating ring shown generally in accordance with teachings of the disclosure.

FIG. 3 is a cross-sectional view of another embodiment of a mating ring shown generally in accordance with teachings of the disclosure.

FIG. 4 is a cross-sectional view of another embodiment of a mating ring shown generally in accordance with teachings of the disclosure.

FIG. 5 is a cross-sectional view of an embodiment of a mating ring shown generally in accordance with teachings of the disclosure.

FIG. 6 is a cross-sectional view of an embodiment of a mating ring including a plurality of inserts and generally illustrating aspects or teachings of the disclosure.

FIGS. 7-12 are cross-sectional views of embodiments of a mating ring generally illustrating various forms of inserts and aspects or features of the disclosure.

FIGS. 13-15 are cross-sectional views of embodiments of a mating ring secured to a base in various ways and in accordance with aspects or features of the disclosure.

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by appended claims.

FIGS. 1 and 2 generally illustrates a cross-section of an embodiment of a seal assembly 18. The illustrated seal assembly includes a shaft 20, a clamp (illustrated in FIG. 1 as elements 22A and 22B), a stator 30, a mating ring 50.

A stator 30 may comprise a housing 32 and a movable seal 34 having a sealing surface 36. With embodiments, a movable seal 34 may comprise, for example and without limitation, a carbon seal, a bellows, and/or an O-ring, and may be connected to a bracket 40. Seal sealing surface 36 may be configured to contact (e.g., mate with and/or operatively “seal”) a mating ring 50, and may be biased toward mating ring 50, for example, via a biasing member 38. A biasing member 38 may, for example and without limitation, comprise a spring or spring-like member. In embodiments, a biasing member 38 may be connected to a housing 32 and a bracket 40.

Mating ring 50 may also be referred to as a rotor. Mating ring 50 may comprise a base 60 and an insert 80. A base 60 may be coupled with an insert 80 to form a multi-part or composite component. In embodiments, such as those generally illustrated, base 60 includes at least a portion configured to receive at least a portion an insert 80. As generally shown, with embodiments, the insert 80 may be received and retained on a side of a base 60 generally disposed opposite an associated sealing surface (e.g., seal sealing surface 36).

In embodiments, base 60 may comprise at least one material with relatively high strength properties and relatively low thermal expansion properties, for example and without limitation, stainless steel. Base 60 may also comprise at least one stress relieving portion 62, which may be curved and/or may be configured to reduce stress. Base 60 may also comprise at least one securing portion 64 configured for securing mating ring 50 relative to shaft 20. Mating ring 50 may be fixedly or movably secured relative to shaft 20, for example, via a clamp, which may be referred to collectively although comprised of multiple components. For example and without limitation, an embodiment of a clamp is general illustrated in FIG. 1 as clamp components 22A and 22B. When employed, such clamp components 22A and 22B, may comprise different materials than the associated rotor. Further, in embodiments, clamp components, such as 22A and 22B, may comprise different materials. By way of example, and without limitation, one clamp component may comprise a titanium alloy, and the other clamp component may comprise a bearing steel.

A clamp may comprise various forms and configurations and may, for example and without limitation, comprise a known or conventional clamp, a bearing, and/or an impeller. Securing portion 64 may also be configured for securing mating ring 50 in a free floating arrangement. In a free floating arrangement, at least a portion of mating ring 50 may be secured between a shoulder of a shaft 20 and a stator 30.

Base 60 may also comprise at least one sealing surface 66. The base 60 and movable seal 34 may be configured such that at least a portion of sealing surface 66 of the base 60 and at least a portion of the seal sealing surface 36 mate and/or operationally seal. In embodiments, base sealing surface 66 and/or seal sealing surface 36 may include at least one groove 68, such as, for example and without limitation, hydrodynamic grooves as generally disclosed in U.S. Patent Application Publication No. 2006/0244221 (Villeneuve et al.).

With a number of embodiments, base 60 may include at least one recess 70 configured to receive at least a portion of an insert 80. Recess 70 may comprise a variety of different shapes, sizes, cross-sections, orientations, and/or positions. Recess 70 may be configured to be the same or substantially similar to a portion or segment of an associated insert 80 that is intended to be received by or within such recess 70. In an embodiment, base 60 may also include at least one projection 72 (see, e.g., FIG. 10) that may be configured to be at least partially received by a portion of insert 80.

While base 60 may include a recess 70, a recess 70 is not required to receive a portion of an insert with all base embodiments. As generally illustrated in FIGS. 4 and 12, the concept includes embodiments in which an insert 80 may be provided adjacent to and/or may abut at least a portion or surface of a base 60.

Insert 80 may comprise at least one material, and may have a greater coefficient of thermal expansion than base 60. Insert 80 may comprise, without limitation, aluminum and/or tungsten. For example, the coefficient of thermal expansion of insert 80 may, for example an and without limitation, be 1.5 or 2 or more times greater than the coefficient of thermal expansion of base 60. Insert 80 may, additionally or alternatively, have greater thermal conductivity than base 60. For example, the thermal conductivity of insert 80 may, without limitation, be 1.5 or 2 or more times greater than the thermal conductivity of base 60.

As generally illustrated in FIGS. 1-15, in embodiments, insert 80 may comprise a plurality of shapes, sizes, cross-sections, and/or orientations. Further, with embodiments, an insert 80 may be disposed in various positions or locations. For example, as generally illustrated in FIG. 1, insert 80 may be located at a radial distance D from shaft 20, or as generally illustrated in FIGS. 3 and 4, at least a portion of insert 80 may be disposed adjacent shaft 20. At least a portion of insert 80 may be inserted and/or pressed into base 60 with a fit that, for some embodiments, may comprise a slight interference fit. As inserted, insert 80 may comprise a first portion 82 that may be within recess 70 and a second portion 84 may be outside of recess 70. Insert 80 may also comprise a securing portion 94. As generally illustrated in FIG. 11, insert 80 may also be inserted and/or pressed into base 60 such that all of insert 80 is disposed within recess 70. As generally illustrated in FIGS. 8 and 9, insert 80 may have a projection 96 configured to be at least partially received by recess 70. As generally illustrated in FIG. 10, insert 80 may comprise a recess 86 configured to receive base projection 72.

As generally illustrated in FIG. 6, mating ring 50 may comprise a plurality of inserts 80. In embodiments with more than one insert 80, inserts 80 may be substantially the same shape or may be different shapes. Inserts 80 may be generally annular or may be configured to be combined into a generally annular arrangement.

As generally illustrated in FIGS. 13-15, insert 80 may be coupled to base 60 in at least one of a variety of ways. For example, and without limitation, insert 80 may comprise at least one lip 88 near its inner diameter and/or outer diameter, which may provide a retention and/or a rollover feature or arrangement. As another non-limiting example, insert 80 may be secured with a mechanical assembly 90, such as, without limitation, at least one retaining ring and/or at least one retaining pin. As a further non-limiting example, insert 80 may be secured via welding (e.g. weldments 92).

Shaft 20 and mating ring 50 may be configured to rotate about an axis A and relative to stator 30. As shaft 20 and mating ring 50 rotate, mating ring 50 and stator 30 may come into contact, which may result in friction. This friction may create heat, which may increase the temperature of base 60. In some situations, increased base 60 temperature could potentially be undesirable.

Insert 80 may be configured to draw at least some heat out from base 60, for example, without limitation, into first portion 82. Heat drawn out from base 60 may reduce excess heat near sealing surface 66 and may reduce undesirable deformations of sealing surface 66, such as, without limitation, coning and/or curing. Insert 80 may also at least partially even out the thermal profile of at least a portion of mating ring 50.

Insert 80 may also generally be configured to expand. Such expansion may result from insert 80 increasing in temperature, for example, by absorbing heat from base 60. If insert 80 has a greater coefficient of thermal expansion than base 60, insert 80 may expand at a greater rate than base 60. Expansion of insert 80 may be in a plurality of directions, which may include a direction P (see, e.g., FIG. 5) generally parallel to base sealing surface 66. Expansion of insert 80 in direction P—which may be generally parallel to sealing face 66—may counteract or reduce a curling or bending effect associated with base 60. For example, without limitation, as insert 80 may (by virtue of its material properties and configuration) expand at a greater rate than base 60, as such insert 80 may cause or urge sealing surface 66 to remain in its initial state and/or return to its initial state. The initial state of sealing surface 66 may, in embodiments, be generally parallel to seal sealing surface 36. Insert 80 may, additionally or alternatively, cause sealing surface 66 to at least partially flatten out and/or remain flat.

A configuration with a composite mating ring comprised of a base 60 and an insert 80, as disclosed, can provide certain advantages. With embodiments, the base 60 may be comprised of a high strength material with comparatively lower thermal expansion properties, while an insert 80 may be comprised of a material with a comparatively higher conductivity and expansion rate (e.g., aluminum, tungsten, etc.). With conventional mating rings that have a single base material, there may be an uneven heat profile across its mating face, particularly if hydrodynamic grooves are employed in connection with the face. The thermals created can cause such a conventional mating ring to “cone” divergently out of flat (an undesirable condition which in instances can impede lift-off). With embodiments of the disclosed concept, an insert can draw heat to better even out a thermal profile while also expanding and serving to address or “correct” face flatness.

Systems and apparatus according to the present disclosure may provide several additional advantages over known systems. For example, and without limitation, in an embodiment, mating ring 50 may be initially clamped with sealing surface 66 substantially flat and substantially parallel to seal sealing surface 36 without compensation for potential curling.

The foregoing descriptions of specific embodiments of the present invention have been presented for purposes of illustration and description. They are not intended to be exhaustive or to limit the invention to the precise forms disclosed, and various modifications and variations are possible in light of the above teaching. For example, and without limitation, it should be understood that references to an insert also include embodiments with more than one insert. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed:

1. A hydrodynamic mating ring, comprising:
a base;
an insert coupled to the base;
wherein the insert has a coefficient of thermal expansion, the base has a coefficient of thermal expansion, and the insert has a greater coefficient of thermal expansion than the base.

2. The mating ring of claim 1, wherein the coefficient of thermal expansion of the insert is at least one-and-one-half times greater than the coefficient of thermal expansion of the base.

3. The mating ring of claim 1, wherein the coefficient of thermal expansion of the insert is at least two times greater than the coefficient of thermal expansion of the base.

4. The mating ring of claim 1, wherein the insert has a thermal conductivity, the base has a thermal conductivity, and the insert has a greater thermal conductivity than the base.

5. The mating ring of claim 1, wherein the insert is coupled to the base via a retention or roll over feature.

6. The mating ring of claim 1, wherein the insert is coupled to the base via a mechanical feature or component.

7. The mating ring of claim 1, wherein the insert is welded to the base.

8. The mating ring of claim 1, wherein the insert is disposed at a lower radial portion of the base and is configured to be positioned substantially adjacent to a shaft.

9. The mating ring of claim 1, wherein at least half of the insert is disposed within a recess of the base.

10. The mating ring of claim 1, wherein the insert is configured to expand, at least partially, in a direction generally parallel to a base sealing surface.

11. The mating ring of claim 10, wherein the insert is configured to cause or urge a sealing face of the base to remain generally flat.

12. The mating ring of claim 1, wherein the insert is configured to draw heat from the base.

13. The mating ring of claim 1, wherein the insert is configured to even out a thermal profile of the mating ring.

14. The mating ring of claim 1, including a second insert.

15. A hydrodynamic seal assembly comprising:
a stator; and
a composite mating ring, the mating ring including a base comprising a first material and an insert comprising a second material,
wherein the base is configured to receive at least a portion of the insert, the first material has a coefficient of thermal expansion, the second material has a coefficient of thermal expansion, and the second material has higher coefficient of thermal expansion than the coefficient of thermal expansion of the first material.

16. The seal assembly of claim 15, wherein the insert is generally disposed on a side of the mating ring that is opposite of the stator.

17. The seal assembly of claim 15, wherein the insert is configured to expand, at least partially, in a direction generally parallel to a base sealing surface.

18. The seal assembly of claim 17, wherein the insert is further configured to cause or urge a sealing face of the base to remain generally flat.

19. The seal assembly of claim 15, wherein the second material has a greater thermal conductivity than a thermal conductivity of the first material.

20. The seal assembly of claim 15, including a clamp and a shaft.
